(19) United States
(12) Patent Application Publication
(10) Pub. No.: US 2022/0385078 A1
(43) Pub. Date: Dec. 1, 2022

(54) CHARGING CONTROL DEVICE, VEHICLE, CHARGING CONTROL METHOD, AND STORAGE MEDIUM STORING CONTROL PROGRAM

(71) Applicants: TOYOTA JIDOSHA KABUSHIKI KAISHA, Toyota-shi (JP); DENSO TEN Limited, Kobe (JP)

(72) Inventors: Sunao HORITAKE, Toyota-shi (JP); Kohei TAKAHASHI, Toyota-shi (JP); Toshiki SHINOHARA, Toyota-shi (JP); Hiroki ONOYAMA, Anjo-shi (JP); Takaya KOSHII, Nagoya-shi (JP); Yuki SHIOZUMI, Kobe (JP)

(73) Assignees: TOYOTA JIDOSHA KABUSHIKI KAISHA, Toyota-shi (JP); DENSO TEN Limited, Kobe (JP)

(21) Appl. No.: 17/746,388

(22) Filed: May 17, 2022

(30) Foreign Application Priority Data
May 25, 2021 (JP) 2021-087647

(51) Int. Cl. H02J 7/00

(52) U.S. Cl. CPC H02J 7/0016; H02J 7/0048; H02J 7/007186

(57) ABSTRACT

A charging control device includes a processor. The processor is configured to control charging of a plurality of battery cells that configure an assembled battery, during charging, in a case in which a voltage value of a battery cell having a highest voltage among the plurality of battery cells is equal to or greater than a threshold value and a current value is equal to or less than a set value, measure a closed circuit voltage (CCV) of the plurality of battery cells, and for a battery cell for which a potential difference with respect to a voltage of a battery cell with a lowest measured CCV is equal to or greater than a predetermined value, execute discharging processing so as to eliminate the potential difference.

### CROSS-REFERENCE TO RELATED APPLICATION

This application is based on and claims priority under 35 USC 119 from Japanese Patent Application No. 2021-087647 filed on May 25, 2021, the disclosure of which is incorporated by reference herein.

### BACKGROUND

### Technical Field

The present disclosure relates to a charging control device, a vehicle, a charging control method, and a storage medium storing a control program.

### Related Art

Japanese Patent Application Laid-Open (JP-A) No. 2018-129958 discloses a charging rate equalization device that equalizes the charging rates of respective battery cells configuring an assembled battery which is a lithium ion battery.

The equalization device collectively charges plural battery cells during a charging process, acquires an open circuit voltage (OCV) after a predetermined period of time has elapsed in a case in which a certain battery cell has reached a maximum voltage, and performs equalization of the battery cells based on the acquired OCV.

Even if an attempt is made to apply the equalization device of JP-A No. 2018-129958 to an auxiliary battery of a vehicle that requires continuous power supply, application of the equalization device is difficult because the auxiliary battery and the load of the vehicle cannot be separated by a relay in order to acquire an OCV.

### SUMMARY

The present disclosure aims to provide a charging control device, a vehicle, a charging control method, and a storage medium storing a control program capable of performing equalization processing even in an assembled battery that cannot be separated from a load.

A first aspect is a charging control device, including: a control unit that controls charging of plural battery cells that configure an assembled battery; a measuring unit that, during charging by control of the control unit, in a case in which a voltage value of a battery cell having a highest voltage among the plural battery cells is equal to or greater than a threshold value and a current value is equal to or less than a set value, measures a closed circuit voltage (CCV) of the plural battery cells; and an executing unit that, for a battery cell for which a potential difference with respect to a voltage of a battery cell with a lowest measured CCV is equal to or greater than a predetermined value, executes discharging processing so as to eliminate the potential difference.

In the charging control device of the first aspect, the measuring unit measures the CCV of each battery cell in a case in which, when the control unit performs charging of the battery cells, the voltage value of the battery cell with the highest voltage during charging is equal to or greater than the threshold value and the current value is equal to or less than the set value. Further, in the charging control device, the executing unit executes discharging processing so as to eliminate the potential difference for a battery cell for which the potential difference with respect to a voltage of a battery cell with the lowest measured CCV is equal to or greater than a predetermined value. The charging control device executes discharging processing of the battery cell with the potential difference based on the CCV, thereby enabling equalization processing to be performed even in an assembled battery that cannot be separated from a load.

The charging control device of the second aspect is the charging control device of the first aspect, wherein the control unit controls such that charging is performed until a predetermined period of time elapses in a region in which a voltage during charging is a high voltage.

In the charging control device of the second aspect, the control unit performs charging so as to maintain a high state of charge (SOC) of the assembled battery. As a result, equalization processing of the battery cells can be performed in a region in which the voltage fluctuates with respect to the SOC even in an assembled battery including a flat region in which the OCV change in the SOC-OCV curve is small, such as an iron phosphate based lithium ion battery.

The charging control device of the third aspect is the charging control device of the first or second aspect, wherein the measuring unit measures the CCV in a case in which a specific period of time has elapsed in a state in which the current value is equal to or less than the set value.

In the charging control device of the third aspect, the measuring unit measures the CCV in a case in which a specific period of time has elapsed in a state in which the current value is equal to or less than the set value, thereby enabling the polarization in the battery cells to be eliminated as far as possible and enabling the CCV to be measured in a state close to the OCV. As a result, accurate battery cell equalization processing can be performed even in a case in which a CCV is used.

The fourth aspect is a vehicle, including the charging control device of any one of the first to third aspects, and a charging device that performs charging of the assembled battery.

In the vehicle of the fourth aspect, battery cell equalization processing can be performed even in an auxiliary battery in which the assembled battery cannot cut off power supply and continuously supplies power to auxiliary equipment.

The fifth aspect is a charging control method, wherein a computer executes processing, the processing including: controlling charging plural battery cells that configure an assembled battery; during charging, in a case in which a voltage value of a battery cell having a highest voltage among the plural battery cells is equal to or greater than a threshold value and a current value is equal to or less than a set value, measuring a closed circuit voltage (CCV) of the plural battery cells; and for a battery cell for which a potential difference with respect to a voltage of a battery cell with a lowest measured CCV is equal to or greater than a predetermined value, executing discharging processing so as to eliminate the potential difference.

In the charging control method of the fifth aspect, when a computer performs charging of battery cells, the CCV of each battery cell is measured in a case in which the voltage value of the battery cell with the highest voltage during charging is equal to or greater than the threshold value and the current value is equal to or less than the set value. The computer then executes discharging processing so as to eliminate the potential difference for a battery cell for which the potential difference with respect to a voltage of a battery cell with the lowest measured CCV is equal to or greater than a predetermined value. According to the charging control method, by executing discharging processing of the battery cell with the potential difference based on the CCV, equalization processing can be performed even in an assembled battery that cannot be separated from a load.

The sixth aspect is a non-transitory storage storing a control program. The program is executable by a computer to perform processing including: controlling charging of plural battery cells that configure an assembled battery; during charging, in a case in which a voltage value of a battery cell having a highest voltage among the plural battery cells is equal to or greater than a threshold value and a current value is equal to or less than a set value, measuring a closed circuit voltage (CCV) of the plural battery cells; and for a battery cell for which a potential difference with respect to a voltage of a battery cell with a lowest measured CCV is equal to or greater than a predetermined value, executing discharging processing so as to eliminate the potential difference.

The control program of the sixth aspect causes a computer to execute the following processing. When the computer performs charging of the battery cells, the CCV of each battery cell is measured in a case in which the voltage value of the battery cell with the highest voltage during charging is equal to or greater than the threshold value and the current value is equal to or less than the set value. The computer then executes discharging processing so as to eliminate the potential difference for a battery cell for which the potential difference with respect to a voltage of a battery cell with the lowest measured CCV is equal to or greater than a predetermined value. The control program executes discharging processing of the battery cell with the potential difference based on the CCV, thereby enabling equalization processing to be performed even in an assembled battery that cannot be separated from a load.

According to the present disclosure, equalization processing can be performed even in an assembled battery that cannot be separated from a load.

### BRIEF DESCRIPTION OF THE DRAWINGS

An exemplary embodiment of the present disclosure will be described in detail based on the following figures, wherein:

FIG. 1 is a schematic configuration view of a vehicle and a power supply system according to an embodiment;

FIG. 2 is a block diagram showing a hardware configuration in a monitoring unit of the embodiment;

FIG. 3 is a block diagram showing a functional configuration of a CPU in the monitoring unit of the embodiment;

FIG. 4 is a flowchart showing the flow of equalization processing in the embodiment; and

FIG. 5 shows the correspondence relationship between SOC and OCV of an iron phosphate based lithium ion battery.

### DETAILED DESCRIPTION

Detailed explanation follows regarding an example of an embodiment of the present disclosure, with reference to the drawings. The charging control device of the present disclosure is incorporated in a power supply system in a vehicle. The charging control device performs processing to equalize the state of charge (SOC: charging rate) of each battery cell in an iron phosphate based lithium ion battery (hereafter referred to as “equalization processing”).

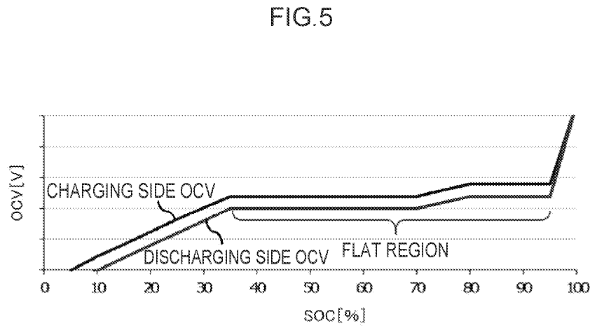

FIG. 5 illustrates a correspondence relationship between SOC and OCV of an iron phosphate based lithium ion battery. As shown in FIG. 5, in an iron phosphate based lithium ion battery, both the charging side OCV indicating OCV during charging and the discharging side OCV indicating OCV during discharging have a flat region, in which the change in OCV is small, from 35 to 95% of the SOC. Further, as the voltage difference between the charging side OCV and the discharging side OCV indicates, an iron phosphate based lithium ion battery has hysteresis during charging and discharging. Due thereto, it is difficult to perform equalization processing based on OCV, which is equivalent equalization processing to a ternary lithium ion battery in which the correspondence relationship between SOC and OCV is unique and there is little hysteresis during charging and discharging.

Further, in a case of a battery that continuously supplies power to auxiliary equipment, such as an auxiliary battery, it is not possible to cut off a load from the auxiliary battery using a relay, and therefore, it is difficult to measure OCV. Accordingly, the charging control device of the present disclosure realizes equalization processing through monitoring using a CCV.

(Configuration)

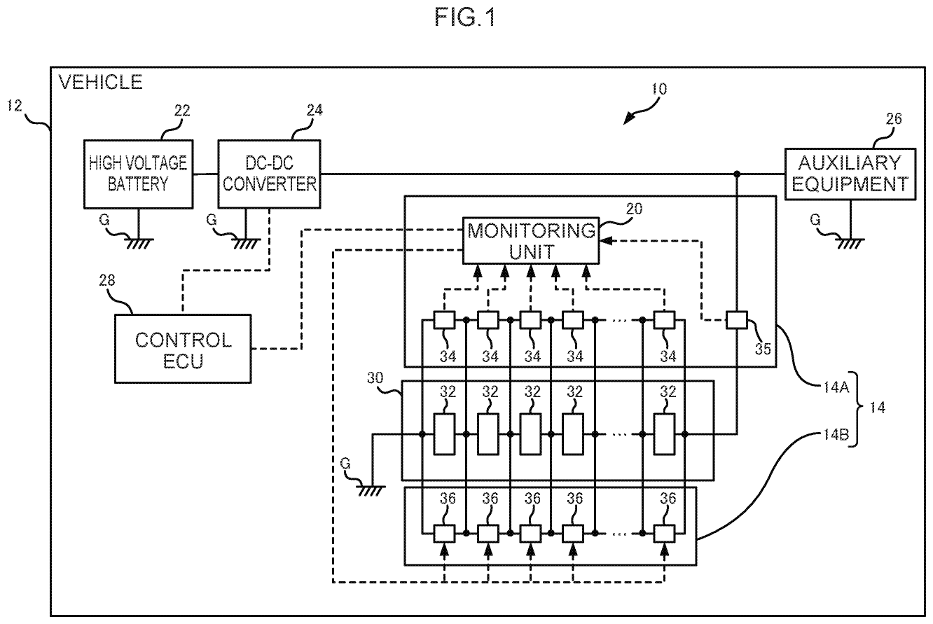

As shown in FIG. 1, a power supply system 10 of the present embodiment is installed at a vehicle 12. Examples of the vehicle 12 include an electric vehicle (EV) or a hybrid electric vehicle (HEV). The vehicle 12 of the present embodiment is supplied with power by the power supply system 10. The vehicle 12 includes auxiliary equipment 26 which is a device configured to operate respective units of the vehicle 12, and a control ECU 28 that controls respective units of the vehicle 12, including the auxiliary equipment 26.

The power supply system 10 includes a monitoring ECU 14 serving as the charging control device, a high voltage battery 22, a DC-DC converter 24, and an auxiliary battery 30 serving as an auxiliary battery. Note that in FIG. 1, reference letter G denotes ground. Details of the monitoring ECU 14 are described below.

The high voltage battery 22 is a high voltage battery for operating a drive motor or the like involved in driving the vehicle 12, and is configured by a rechargeable secondary battery such as a lithium ion battery or a nickel-metal hydride battery. The high voltage battery 22 is connected to a DC-DC converter 24.

The DC-DC converter 24 has a function of supplying power that is output from the high voltage battery 22 to the auxiliary battery 30 and to the auxiliary equipment 26 serving as a load. The high voltage battery 22 is connected to an input side of the DC-DC converter 24, and the auxiliary battery 30 and the auxiliary equipment 26 are connected to an output side of the DC-DC converter 24. During power supply, the DC-DC converter 24 steps down the output voltage of the high voltage battery 22, which is an input voltage, to a predetermined voltage based on an instruction from the control ECU 28, and outputs this voltage to the auxiliary battery 30 and the auxiliary equipment 26. The DC-DC converter 24 of the present embodiment is an example of a charging device.

The control ECU 28 is configured by, for example, a microcomputer, and has a function of controlling the DC-DC converter 24. As a result, the control ECU 28 supplies power from the high voltage battery 22 to the auxiliary battery 30 and the auxiliary equipment 26 via the DC-DC converter 24.

The auxiliary battery 30 is a battery capable of operating the auxiliary equipment 26. The auxiliary battery 30 of the present embodiment is a rechargeable iron phosphate based lithium ion battery. Further, the auxiliary battery 30 is an assembled battery configured by plural battery cells 32. The auxiliary battery 30 is connected to the DC-DC converter 24, and is capable of receiving power from the DC-DC converter 24. Further, the auxiliary battery 30 is connected to the auxiliary equipment 26 of the vehicle 12, and supplies power to the auxiliary equipment 26.

The monitoring ECU 14 includes a monitoring unit 14A and a discharge unit 14B. The monitoring unit 14A includes a monitoring unit 20 configured by a microcomputer, plural voltmeters 34 provided for each battery cell 32, and an ammeter 35 provided on a wiring of the auxiliary battery 30. The discharge unit 14B includes plural discharge units 36 provided for each battery cell 32. Each discharge unit 36 includes, for example, a discharge resistor connected to the battery cell 32, and a switch that controls current flow from the battery cell 32 to the resistor.

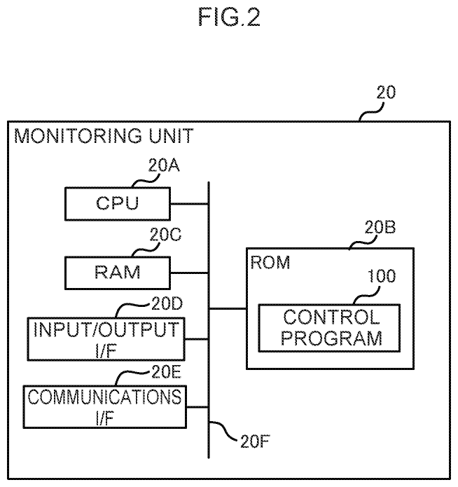

As shown in FIG. 2, the monitoring unit 20 includes a central processing unit (CPU) 20A, read only memory (ROM) 20B, random access memory (RAM) 20C, an input/output interface (I/F) 20D, and a communications I/F 20E. The CPU 20A, the ROM 20B, the RAM 20C, the input/output I/F 20D, and the communications I/F 20E are communicably connected to each other via an internal bus 20F.

The CPU 20A is a central processing unit that executes various programs and controls the respective units. That is, the CPU 20A reads a program from the ROM 20B, and executes the program employing the RAM 20C as a workspace.

The ROM 20B stores various programs and various data. A control program 100 is stored in the ROM 20B of the present embodiment.

The control program 100 is a program for controlling the monitoring unit 20. The monitoring unit 20, which is controlled by the control program 100, controls charging and discharging of the auxiliary battery 30.

The RAM 20C serves as a workspace for temporary storage of programs and data.

The input/output I/F 20D is an interface for electrically connecting the monitoring unit 20 and each voltmeter 34, the ammeter 35, and each discharge unit 36.

The communications/F 20E is an interface for connecting to each ECU, such as the control ECU 28. For the interface, a communication standard based on the CAN protocol is used, for example. The monitoring unit 20 is capable of controlling the DC-DC converter 24 via the control ECU 28, which is connected to the communications I/F 20E, to control charging of the auxiliary battery 30.

The monitoring unit 20 may include a storage as a storage unit in addition to, or in place of, the ROM 20B. This storage is configured by, for example, a hard disk drive (HDD) or a solid state drive (SSD).

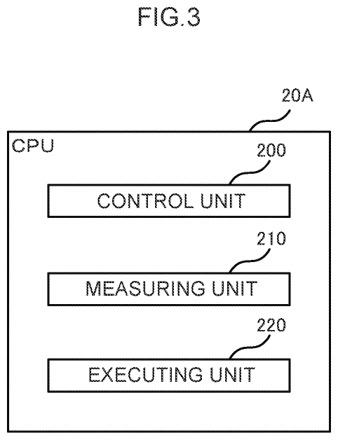

As shown in FIG. 3, in the monitoring unit 20 of the present embodiment, the CPU 20A functions as the control unit 200, the measuring unit 210, and the executing unit 220 by executing the control program 100.

The control unit 200 has a function of controlling charging of the auxiliary battery 30. The control unit 200 of the present embodiment controls charging of the respective battery cells 32 so as to perform charging until a predetermined period of time has elapsed in a region in which the voltage during charging is a high voltage. Here, the “region in which the voltage during charging is a high voltage” is a region in which the SOC is higher than the flat region and the voltage of the battery cell 32 changes with respect to the SOC (see FIG. 5). Further, the “predetermined period of time” is a period of time required at least until the current value and the voltage value are stabilized.

The measuring unit 210 has a function of measuring the voltage of each battery cell 32 using the voltmeter 34 and measuring the current of the auxiliary battery 30 using the ammeter 35. The measuring unit 210 of the present embodiment measures the CCV of the plural battery cells 32 during charging of the auxiliary battery 30 in a case in which the voltage value of the battery cell having the highest voltage among the plural battery cells 32 is equal to or greater than a threshold value and the current value is equal to or less than a set value. Here, the “threshold value” in the voltage is set to a value that is equal to or greater than the voltage of the battery cell 32 in the flat region (see FIG. 5). That is, the threshold value is a voltage value at which the voltage of the battery cell 32 changes with respect to the SOC. Further, the “set value” of the current is set to a current value that can allow a decrease in voltage which accompanies the internal resistance of the battery cell 32.

Further, the measuring unit 210 measures the CCV in a case in which a specific period of time has elapsed in a state in which the current value is equal to or less than the set value. Here, the “specific period of time” is set to at least a period of time during which polarization in the battery cells 32 is eliminated.

The executing unit 220 has a function of executing discharging of the respective battery cells 32 using the discharge units 36. The executing unit 220 of the present embodiment executes discharging processing for a battery cell for which a potential difference with respect to a voltage of a battery cell with the lowest measured CCV is equal to or greater than a predetermined value. Here, the “predetermined value” is set to a value obtained by converting an error included in sensors such as the voltmeters 34 and the ammeter 35 into a voltage value and accumulating the voltage values.

(Control Flow)

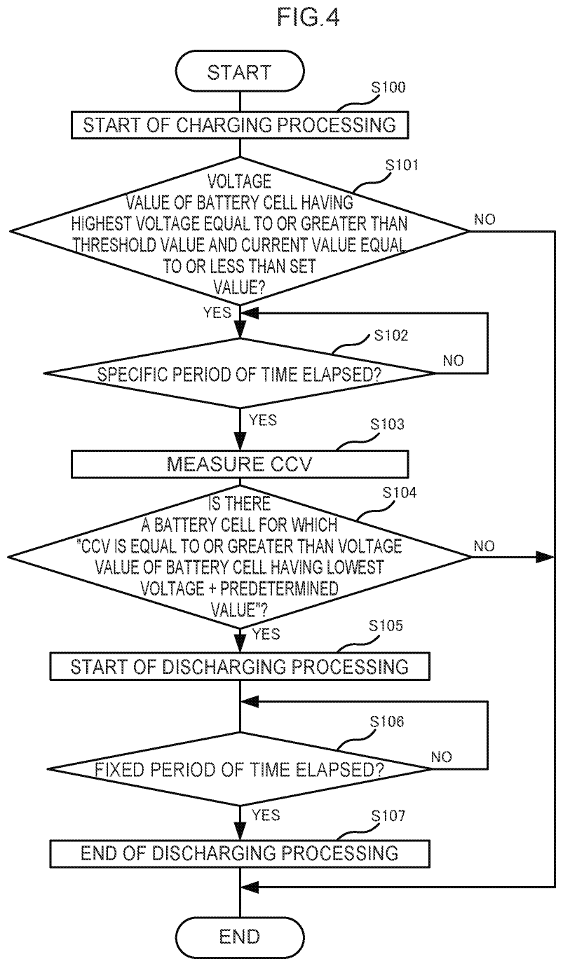

The flow of equalization processing serving as a charging control method executed at the monitoring unit 20 of the present embodiment is described with reference to the flowchart of FIG. 4. The equalization processing at the monitoring unit 20 is realized by the CPU 20A functioning as the control unit 200, the measuring unit 210, and the executing unit 220 described above.

In step S100 of FIG. 4, the CPU 20A starts the charging processing. The CPU 20A performs the charging processing until a region in which the voltage of the auxiliary battery 30 is a high voltage, and maintains a region in which each battery cell 32 is at a high voltage. Here, the CPU 20A maintains the charging processing for a period of time at least until the current value and the voltage value are stabilized.

In step S101, the CPU 20A performs a determination as to whether or not the voltage value of the battery cell 32 having the highest voltage is equal to or greater than a threshold value and the current value is equal to or less than a set value. In a case in which the CPU 20A determines that the voltage value of the battery cell 32 having the highest voltage is equal to or greater than the threshold value and the current value is equal to or less than the set value (the case of YES in step S101), the processing proceeds to step S102. On the other hand, in a case in which the CPU 20A determines that the voltage value of the battery cell 32 having the highest voltage is not equal to or greater than the threshold value and/or the current value is not equal to or less than the set value (the case of NO in step S101), the equalization processing is ended.

In step S102, the CPU 20A performs a determination as to whether or not a specific period of time has elapsed. In a case in which the CPU 20A determines that the specific period of time has elapsed (the case of YES in step S102), the processing proceeds to step S103. On the other hand, in a case in which the CPU 20A determines that the specific period of time has not elapsed (the case of NO in step S102), step S102 is repeated.

In step S103, the CPU 20A measures the CCV. That is, the CPU 20A uses the respective voltmeters 34 to measure the voltage of the respective battery cells 32.

In step S104, the CPU 20A performs a determination as to whether or not there is a battery cell 32 for which the CCV is equal to or greater than the sum of a voltage value of a battery cell 32 having the lowest CCV and the predetermined value; in other words, the CPU 20A performs a determination as to whether or not there is a battery cell 32 for which a potential difference with respect to a voltage of a battery cell 32 with the lowest CCV is equal to or greater than the predetermined value. In a case in which the CPU 20A determines that there is a battery cell 32 for which the CCV is equal to or greater than the sum of a voltage value of the battery cell 32 having the lowest CCV and the predetermined value (the case of YES in step S104), the processing proceeds to step S105. On the other hand, in a case in which the CPU 20A determines that there are no battery cells 32 for which the CCV is equal to or greater than the sum of a voltage value of the battery cell 32 having the lowest CCV and the predetermined value (the case of NO in step S104), the equalization processing is ended.

In step S105, the CPU 20A starts the discharging processing. More specifically, the discharging processing is started for a battery cell 32 for which a potential difference with respect to a voltage of a battery cell 32 with the lowest CCV is equal to or greater than the predetermined value.

In step S106, the CPU 20A performs a determination as to whether or not a fixed period of time has elapsed. In a case in which the CPU 20A determines that the fixed period of time has elapsed (the case of YES in step S106), the processing proceeds to step S107. On the other hand, in a case in which the CPU 20A determines that the fixed period of time has not elapsed (the case of NO in step S106), step S106 is repeated. Here, the “fixed period of time” may be set to a time period during which an imbalance in voltage among the battery cells 32 is eliminated.

In step S107, the CPU 20A ends the discharging processing. Note that the CCV is measured again, and in a case in which a battery cell 32 for which a potential difference with respect to a voltage of a battery cell 32 with the lowest CCV is equal to or greater than the predetermined value remains, the discharging processing may be executed again with respect to this battery cell 32. Then, the equalization processing ends.

### SUMMARY OF THE EMBODIMENT

In the monitoring unit 20 of the present embodiment, the measuring unit 210 measures the CCV of each battery cell 32 in a case in which, when the control unit 200 performs charging of the battery cell 32, the voltage value of the battery cell 32 having the highest voltage during charging is equal to or greater than a threshold value, and the current value is equal to or less than a set value. The executing unit 220 then executes discharging processing so as to eliminate the potential difference with respect to a battery cell 32 for which the potential difference between a voltage of a battery cell 32 with the lowest measured CCV is equal to or greater than the predetermined value. According to the present embodiment, by executing the discharging processing of a battery cell 32 with a potential difference based on the CCV, equalization processing can be performed even in the auxiliary battery 30 that cannot be separated from the auxiliary equipment 26 by a relay.

Further, in the present embodiment, the control unit 200 performs charging so as to maintain a high SOC state of the auxiliary battery 30. As a result, according to the present embodiment, equalization processing of the battery cells 32 can be performed even in an assembled battery including a flat region (see FIG. 5) in which there is little change in OCV in a correspondence relationship between SOC and OCV, such as an iron phosphate based lithium ion battery.

Further, in the present embodiment, by the measuring unit 210 measuring the CCV in a case in which a state in which the current value is equal to or less than the set value has elapsed for a specific period of time, polarization in the battery cells 32 can be eliminated as much as possible, and the CCV can be measured in a state close to the OCV. As a result, according to the present embodiment, equalization processing of the battery cells 32 can be performed with high accuracy even in a case in which a CCV is used.

### NOTES

Although the monitoring ECU 14 corresponding to the charging control device includes the voltmeters 34, the ammeter 35, and the discharge units 36 in the above embodiment, the above embodiment is not limited thereto. The monitoring ECU 14 may include the monitoring unit 20, and the voltmeters 34, the ammeter 35, and the discharge units 36 may each be separate bodies from the monitoring ECU 14.

Further, the equalization processing in the above embodiment may be executed during travel of the vehicle 12 or may be executed in a case in which an external charger is connected when the vehicle 12 is stationary.

In the above-described embodiment, any of various types of processors other than a CPU may execute the various processing that the CPU 20A executes by reading out software (programs). Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, each processing described above may be executed by one of these various types of processors, or may be executed by combining two or more of the same type or different types of processors (e.g., plurals FPGAs, or a combination of a CPU and an FPGA, or the like). Further, a hardware configuration of the various processors is specifically formed as an electric circuit combining circuit elements such as semiconductor elements.

Moreover, in the embodiment described above, cases have been described in which each of the programs is pre-stored (pre-installed) on a non-transitory computer readable storage medium. For example, the control program 100 in the monitoring unit 20 is stored in the ROM 20B in advance. However, there is no limitation thereof, and the respective programs may be provided in a format stored on a non-transitory storage medium such as a Compact Disc Read Only Memory (CD-ROM), Digital Versatile Disc Read Only Memory (DVD-ROM), or Universal Serial Bus (USB) memory. Alternatively, these programs may be provided in a format downloaded from an external device through a network.

The processing flow described in the above embodiment is merely an examples thereof, and unnecessary steps may be omitted, new steps added, or the processing sequence changed within a range not departing from the gist thereof.

What is claimed is:

1. A charging control device, comprising:
a processor, wherein the processor is configured to:
control charging of a plurality of battery cells that configure an assembled battery;
during charging, in a case in which a voltage value of a battery cell having a highest voltage among the plurality of battery cells is equal to or greater than a threshold value and a current value is equal to or less than a set value, measure a closed circuit voltage (CCV) of the plurality of battery cells; and
for a battery cell for which a potential difference with respect to a voltage of a battery cell with a lowest measured CCV is equal to or greater than a predetermined value, execute discharging processing so as to eliminate the potential difference.

2. The charging control device according to claim 1, wherein the processor controls such that charging is performed until a predetermined period of time elapses in a region in which a voltage during charging is a high voltage.

3. The charging control device according to claim 1, wherein the processor measures the CCV in a case in which a specific period of time has elapsed in a state in which the current value is equal to or less than the set value.

4. A vehicle, comprising:
the charging control device according to claim 1; and
a charging device that performs charging of the assembled battery.

5. The vehicle according to claim 4, comprising a load that receives a supply of power from the assembled battery and the charging device.

6. The vehicle according to claim 4, wherein processing by the processor is executed while the vehicle is travelling.

7. A charging control method, by which a computer executes processing comprising:
controlling charging of a plurality of battery cells that configure an assembled battery;
during charging, in a case in which a voltage value of a battery cell having a highest voltage among the plurality of battery cells is equal to or greater than a threshold value and a current value is equal to or less than a set value, measuring a closed circuit voltage (CCV) of the plurality of battery cells; and
for a battery cell for which a potential difference with respect to a voltage of a battery cell with a lowest measured CCV is equal to or greater than a predetermined value, executing discharging processing so as to eliminate the potential difference.

8. A non-transitory storage medium storing a control program executable by a computer to perform processing, the processing comprising:
controlling charging of a plurality of battery cells that configure an assembled battery;
during charging, in a case in which a voltage value of a battery cell having a highest voltage among the plurality of battery cells is equal to or greater than a threshold value and a current value is equal to or less than a set value, measuring a closed circuit voltage (CCV) of the plurality of battery cells; and
for a battery cell for which a potential difference with respect to a voltage of a battery cell with a lowest measured CCV is equal to or greater than a predetermined value, executing discharging processing so as to eliminate the potential difference.
